(19) United States
(12) Patent Application Publication
(10) Pub. No.: US 2007/0229836 A1
(43) Pub. Date: Oct. 4, 2007

(54) Organic Luminescent Surface Plasmon Resonance Sensor

(75) Inventors: Chii-Wann Lin, Taipei (TW); Nan-Fu Chiu, Taipei (TW); Jiun-Haw Lee, Taipei (TW); Lung-Jieh Yang, Taipei (TW); Yao-Joe Yang, Taipei (TW); Chih-Kung Lee, Taipei (TW)

Correspondence Address: YI-MING TSENG, P.O. BOX 19428, STANFORD, CA, 94309-9428, US

(73) Assignee: National Taiwan University, Taipei (TW)

(21) Appl. No.: 11/278,638

(22) Filed: Apr. 4, 2006

(51) Int. Cl. G01N 21/55

(52) U.S. Cl. 356/445

(57) ABSTRACT

One embodiment of the present invention is a sensor for analyzing an analyte that includes: (a) an sensing element that is adapted to interface with the analyte; (b) an organic luminescent element that is adapted to excite surface plasmon resonance on the sensing element; and (c) a detector that is adapted to detect signals from the sensing element.

### TECHNICAL FIELD OF THE INVENTION

One or more embodiments of the present invention relate to surface plasmon resonance (SPR) sensors, and more particularly, to SPR sensors using organic luminescence technology.

### BACKGROUND OF THE INVENTION

Study of chemical mechanisms or processes often requires detecting reactions or interactions of molecules. For example and without limitation, physiological processes in organisms are related to many complicated biochemical mechanisms, which involve interactions of macromolecules with other molecules, and in order to study these complicated biochemical mechanisms, reactions of the macromolecules usually need to be detected. Analytic methods and tools have been developed for detecting molecule reactions and interactions.

Among these analytic methods and tools, surface plasmon resonance (SPR) sensors have become more and more important. A SPR sensor may have a number of advantages, such as high sensitivity, no need of labeling of molecules, real-time measurement of molecular interactions, quick detection, and quantifiable and high throughput screening. It may be applied in detecting interactions of antigens and antibodies, enzymes and substrates, hormones and receptors, and between nucleic acids; further, it may also be combined with biochips to form a new platform for new drug screening. In addition, a SPR sensor may be applied to the analytical chemistry, environmental engineering, or military technology. SPR sensors are commercially available from a supplier such as, for example and without limitation, Texas Instruments Incorporated (www.ti.com) of Attleboro, Mass.

SPR sensors are fabricated based on a principle that when a light beam goes through a medium and hits a metal surface or conductive material surface with a specific incidence angle, the intensity of the reflected light (detected by a photodetector) is close to zero; that is, the reflectance the metal surface approximates zero. The un-reflected light becomes an evanescent wave that propagates parallel to the metal surface (the interface between the medium and a second medium if the metal is a thin film coated on the second medium) at a certain speed. The evanescent wave in turn excites resonance of delocalized electrons on the metal surface (which electrons are called plasmons). Such a phenomenon is known as attenuated total reflection (ATR).

FIG. 1 illustrates configuration of SPR sensor 1 fabricated based on the abovementioned phenomenon. As shown in FIG. 1, SPR sensor comprises: (a) prism 2; (b) a light source (not shown); and a photodetector (not shown). Further, a surface of prism 2 is coated with a 50 nm metal film 4, which may comprise gold or silver. Light beam 3 from the light source enters prism 2, hits metal film 4, and results in reflected light (5). One may analyze an analyte of interest by: (a) disposing the analyte on metal film 4, (b) modulating the incidence angle of light beam 3; (c) detecting the intensity of reflected light 5 using the photodetector; and (d) obtaining a function plot that depicts the relation between the incidence angle and the reflectance of metal film 4. The incidence angle that associates with a dramatic drop of the reflectance of metal film 4 (i.e., the ATR phenomenon) depends on characteristics of the analyte. Therefore, characters of the analyte such as molecular interactions or concentration can be analyzed.

Conventional SPR sensors typically require: (a) an external light source, which is usually a laser light source; and (b) a polarizer for polarizing the light and thereby modulating the incidence angle. Requirements of the external light source and the polarizer make such conventional SPR sensors very expensive and bulky, and therefore limit the use and availability of the SPR sensors.

A different kind of sensor has also been proposed that comprises an organic light-emitting diode or device (OLED) or organic electroluminescent (OEL) device for causing an analyte to emit florescent signals. The intensity of the florescent signals indicates information or characteristics of the analyte such as molecular interaction. However, such OLED sensors require molecules of the analyte to be labeled with fluorescent dye. As a result, processes of molecule interaction may be complicated. Further, bonding of the florescent dye with molecules may cause errors in detection. Still further, such OLED sensors typically require a filter for filtering signals from the light source; the filter may also cause part of the fluorescent signals to be lost. In general, such OLED sensors can only analyze the analytes qualitatively or partially quantitatively, and their results are typically less accurate than those of SPR sensors.

OLED has been extensively studied given its application in displays. It is observed that surface plasmon resonance (SPR) phenomena in OLED cause energy loss and therefore reduced luminescent efficiency. In response, various methods have been proposed for recovering such energy loss and for increasing luminescent efficiency. However, the use of SPR phenomena in OLED for detection purposes have not been addressed.

In light of the above, there is a need in the art for a SPR sensor that solves one or more of the above-identified problems.

### SUMMARY OF THE INVENTION

One or more embodiments of the present invention solve one or more of the above-identified problems. In particular, one embodiment of the present invention is a sensor for analyzing an analyte that includes: (a) an sensing element that is adapted to interface with the analyte; (b) an organic luminescent element that is adapted to excite surface plasmon resonance on the sensing element; and (c) a detector that is adapted to detect signals from the sensing element.

### BRIEF DESCRIPTION OF THE DRAWINGS

FIG. 1 shows a schematic of a typical prior art SPR sensor;

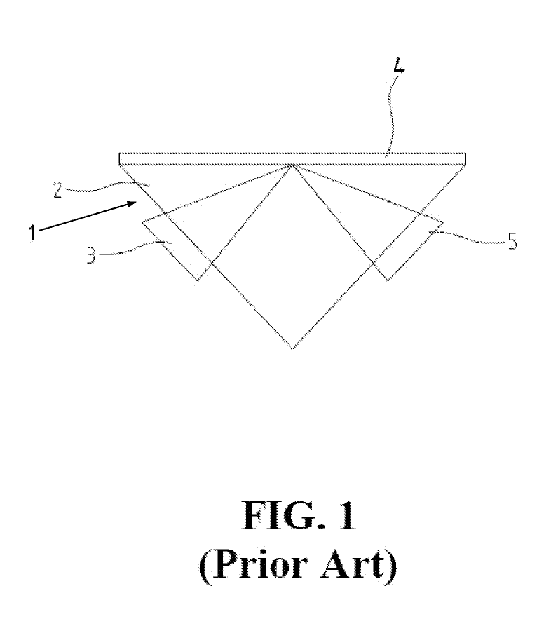

FIG. 2 shows a schematic of an organic electroluminescent (OEL) SPR sensor that is fabricated in accordance with one or more embodiments of the present invention;

FIG. 3 shows a schematic of another OEL SPR sensor that is fabricated in accordance with one or more embodiments of the present invention;

FIG. 4 shows a schematic of still another OEL SPR sensor that is fabricated in accordance with one or more embodiments of the present invention;

FIG. 5 shows a schematic of still another OEL SPR sensor that is fabricated in accordance with one or more embodiments of the present invention;

FIG. 6 shows a result of detecting the SPR angle of water using a OEL SPR sensor that is fabricated in accordance with one or more embodiments of the present invention;

FIG. 7 shows effects of P polarized wave and S polarized wave on detecting the SPR angle of water using a sensor that is fabricated in accordance with one or more embodiments of the present invention;

FIG. 8 shows effects of sensing layer thickness on detecting the SPR angle of water using a sensor that is fabricated using one or more embodiments of the present invention;

FIG. 9 shows effects of light wavelength on detecting the SPR angle of water using a sensor that is fabricated using one or more embodiments of the present invention;

FIG. 10 shows effects of dielectric layer thickness on detecting the SPR angle of water using a sensor that is fabricated using one or more embodiments of the present invention;

FIG. 11 shows effects of cathode layer thickness on detecting the SPR angle of water using a sensor that is fabricated using one or more embodiments of the present invention; and

FIG. 12 shows a result of detecting the SPR angles of water, 100% ethanol, and 50% glucose solution using a sensor that is fabricated using one or more embodiments of the present invention.

### DETAILED DESCRIPTION

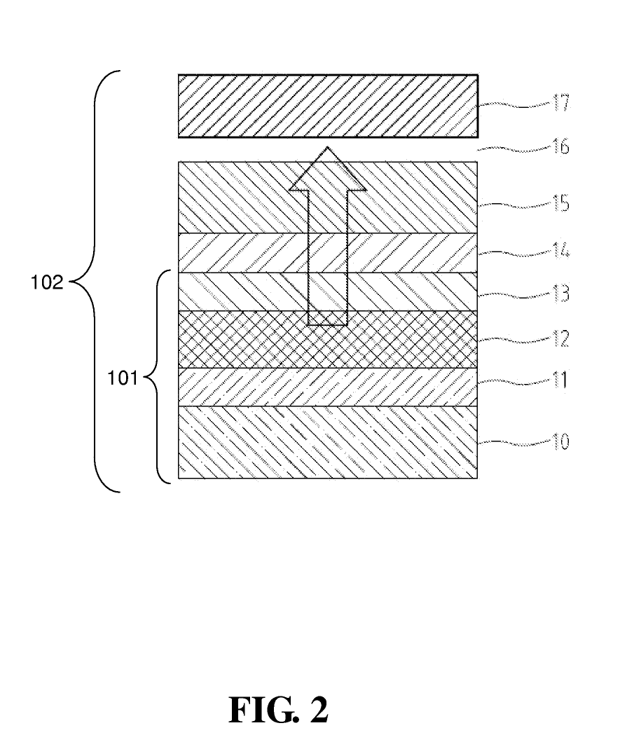

FIGS. 2-5 show schematic cross-section views of sensors 102, 103, 104, and 105, respectively; each of sensors 102-105 is fabricated in accordance with one or more embodiments of the present invention. As shown in FIGS. 2-5, each of sensors 102-105 includes: (a) sensing layer 15; (b) organic luminescent element 101 that is adapted to excite surface plasmon resonance on sensing layer 15; and (c) detector 17 that is adapted to detect signals from sensing layer 15. Further, as shown in FIGS. 2-5, each of sensors 102-105 further includes analyte-loading structure 16 that is disposed between sensing layer 15 and detector 17 and is adapted to enable the analyte to interface with sensing layer 15. Still further, as shown in FIGS. 2-5, each of sensors 102-105 further includes dielectric layer 14.

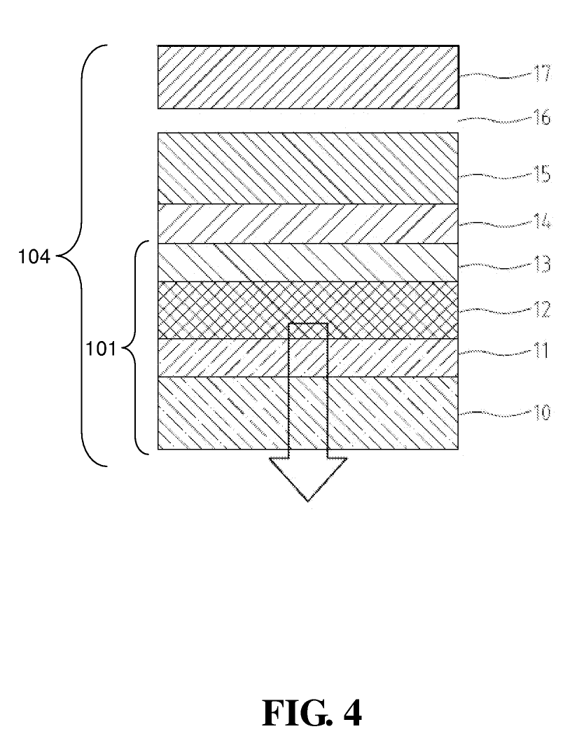

As shown in FIGS. 2 and 4, in each of sensors 102 and 104, dielectric layer 14 is disposed between organic luminescent element 101 and sensing layer 15 and is attached to cathode layer 13. In accordance with one or more embodiments of the present invention, sensor 102 (shown in FIG. 2) is adapted to utilize a cathode-luminescent scheme. In accordance with one or more embodiments of the present invention, sensor 104 (shown in FIG. 4) is adapted to utilize a substrate-luminescent scheme.

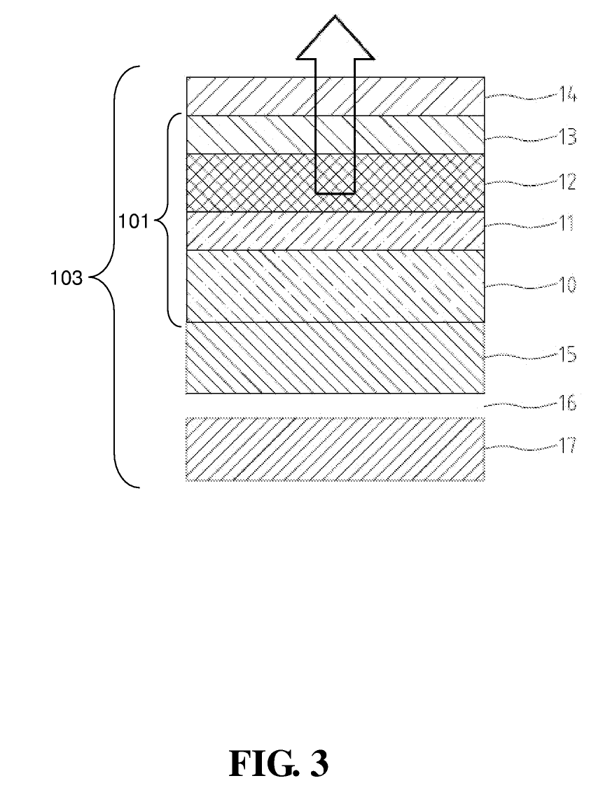

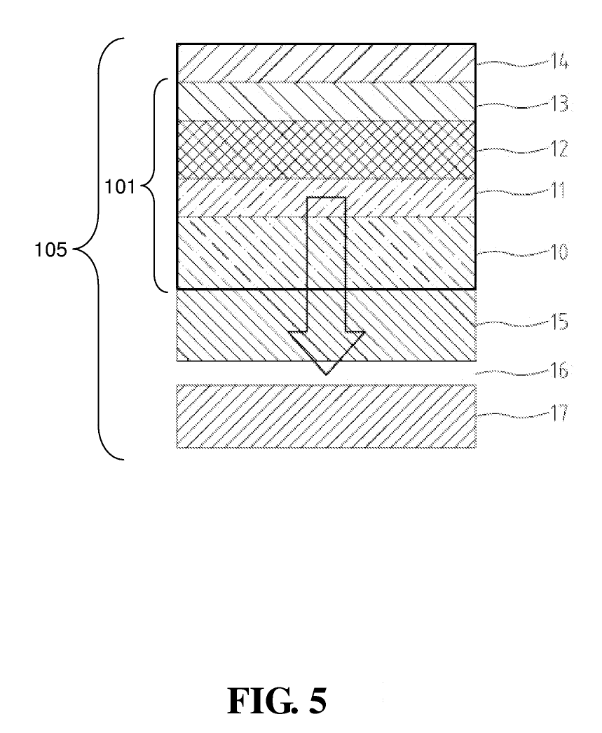

As shown in FIGS. 3 and 5, in each of sensors 102 and 104, organic luminescent element 101 is disposed between dielectric layer 14 and sensing layer 15, and dielectric layer 14 is attached to cathode layer 13. In accordance with one or more embodiments of the present invention, sensor 103 (shown in FIG. 3) is adapted to utilize a cathode-luminescent scheme. In accordance with one or more embodiments of the present invention, sensor 105 (shown in FIG. 5) is adapted to utilize a substrate-luminescent scheme.

In accordance with one or more embodiments of the present invention, sensing layer 15 (shown in FIGS. 2-5) includes one or more layers of organic, inorganic, metal, precious metal, polymer conductive material that is well known to one of ordinary skill in the art such as, for example and without limitation, gold (Au). Further, in accordance with one or more embodiments of the present invention, sensing layer 15 comprises a structure that is adapted to enhance surface plasmon (SP) modes such as, for example and without limitation, a thin-film structure with a depth in a range of 1 nm to 500 nm, nanoscale multilayer structure (symmetric and/or asymmetric), periodic grating microstructure, two-dimensional microarray structure, or periodic structure with a period size in a range of 10 nm to 1000 nm. Still further, in accordance with one or more embodiments of the present invention, sensing layer 15 comprises micro- or nano-particles, such as Ag nano-particles, to enhance surface plasmon resonance (SPR) signals. In accordance with one or more embodiments of the present inventions, sensing layer 15 comprises a binding material that can bind with a analyte such as, for example and without limitation, a protein or nucleic acid. In accordance with one or more embodiments of the present inventions, ligands or probes may be disposed on sensing layer 15 prior to loading an analyte. In accordance with one or more embodiments of the present invention, sensing layer 15 comprises one or more microlens that are adapted to enhance efficiency of light emission.

As further shown in FIGS. 2-5, in accordance with one or more embodiments of the present invention, organic luminescent element 101 includes: (a) substrate 10; (b) anode layer 11, which is attached to substrate 10; (c) cathode layer 13; and (d) organic layer 12, which is sandwiched between anode layer 11 and cathode layer 13 as in a typical organic electroluminescent (OEL) device or organic light-emitting device (OLED) structure. In accordance with one or more embodiments of the present invention, organic luminescent element 101 is adapted to emit light with a wavelength in the range of 300 to 850 nm.

In accordance with one or more embodiments of the present invention, substrate 10 (shown in FIGS. 2-5) includes a material that is well known to one of ordinary skill in the art such as, for example and without limitation, semiconductor, quartz, glass, or polymer. In accordance with one or more embodiments of the present invention, anode layer 11 includes a metal, precious metal, or conductive polymer material that is well known to one of ordinary skill in the art such as, for example and without limitation, silver (Ag). In accordance with one or more embodiments of the present invention, organic layer 12 includes one or more layers of organic material that is well known to one of ordinary skill in the art such as, for example and without limitation, aluminum tris-8-hydroxyquinoline (Alq3) or poly(2-methoxy, 5-(2′-ethyl-hexyloxy) 1,4-phenylenevinylene (MEH-PPV). In accordance with one or more embodiments of the present invention, cathode layer 13 includes a metal, precious metal, or conductive polymer material that is well known to one of ordinary skill in the art such as, for example and without limitation, indium-tin-oxide (ITO).

In accordance with one or more embodiments of the present invention, detector 17 (shown in FIGS. 2-5) is adapted to detect one or more signals such as, for example and without limitation, light resonance angles, light intensities, light wavelengths, angle-adjusting signals, light intensity-adjusting signals, or wavelength-adjusting signals. In accordance with one or more such embodiments, detector 17 includes a photodetector that is well known to one of ordinary skill in the art such as, for example and without limitation, a photomultiplier tube (PMT), photodiode, charge coupled device (CCD), or complementary metal oxide semiconductor (CMOS) image sensor. In accordance with one or more alternative embodiments of the present invention, detector 17 is installed external to sensor 102, 103, 104, or 105. In accordance with one or more embodiments of the present invention, detector 17 is electrically or wirelessly connected to a data processing device such as, for example and without limitation, a data processing chip, a personal digital assistant (PDA), a computer, or a mobile device. In turn, the processed signals may be output through an output device. In accordance with one or more embodiments of the present invention, the data processing device is an integral part of sensor 102, 103, 104, or 105.

In accordance with one or more embodiments of the present invention, dielectric layer 14 (shown in FIGS. 2-5) includes a conventional organic or inorganic waterproof material that is well known to one of ordinary skill in the art such as, for example and without limitation, silicon dioxide (SiO₂).

In accordance with one or more embodiments of the present invention, analyte-loading structure 16 (shown in FIGS. 2-5) includes one or more microfluidic channels.

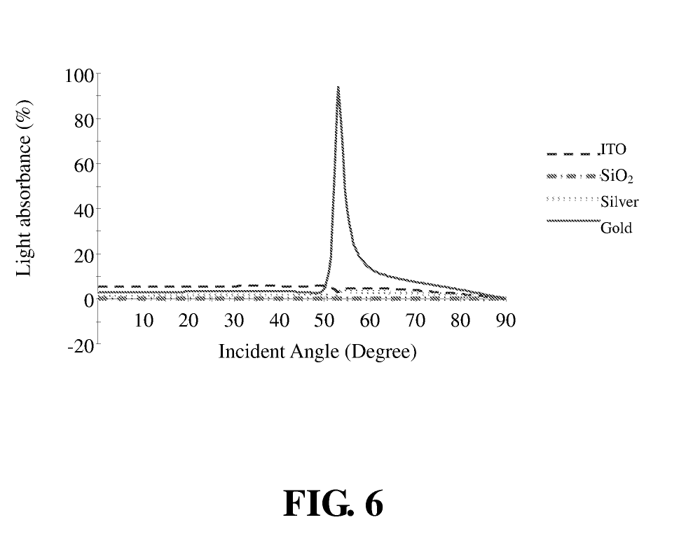

FIG. 6 shows a result of detecting the surface plasmon resonance (SPR) angle of water using sensor 102 (shown in FIG. 2). In accordance with one or more embodiments of the present invention, the basic configuration of sensor 102 includes: cathode layer 13 (shown in FIG. 2) is ITO of 100 nm thickness; dielectric layer 14 (shown in FIG. 2) is SiO₂ of 10 nm thickness; sensing layer 15 (shown in FIG. 2) consists of gold of 40 nm thickness and silver of 10 nm thickness (that is adapted to enhance performance of the gold). Water is loaded into analyte-loading structure 16 (shown in FIG. 2) and light absorbance on sensing layer 15 is detected given light of 650 nm wavelength emitted from organic luminescent element 101. The result shows that the water has a SPR angle of 53 degrees given the above configuration where the light absorbance is 100% as shown in FIG. 6.

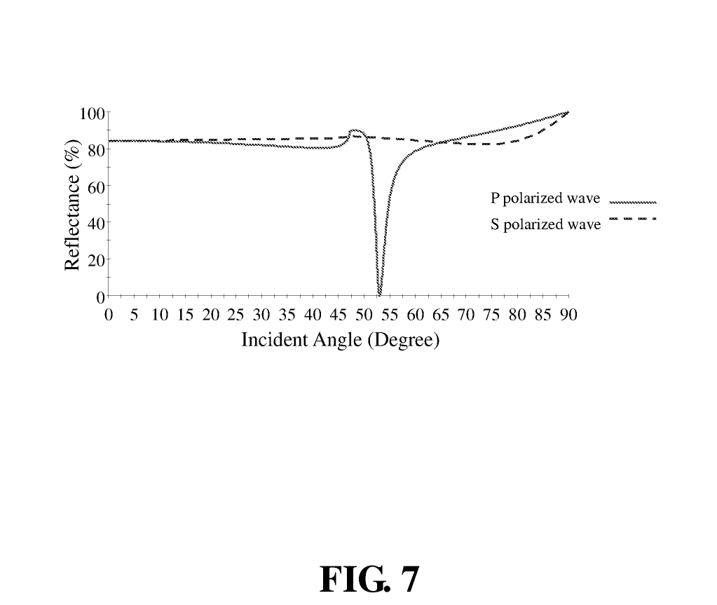

FIG. 7 shows effects of P polarized wave and S polarized wave on detecting the SPR angle of water using sensor 102 (shown in FIG. 2). Given the basic configuration of sensor 102, as shown in FIG. 7, P polarized wave can be used to detect the SPR angle of the water, but S polarized wave cannot. In addition, magnesium fluoride (MgF₂) may be substituted for silicon dioxide (SiO₂) as dielectric layer 14 to provide easier fabrication process of sensor 102 with equivalent performance.

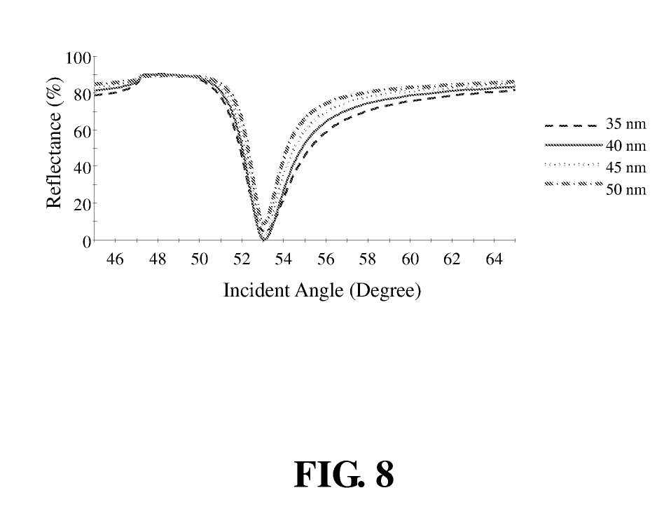

FIG. 8 shows effects of sensing layer thickness on detecting the SPR angle of water using sensor 102 (shown in FIG. 2). Sensor 102 is fabricated according to its basic configuration, except that gold as sensing layer 16 (shown in FIG. 2) of 30 nm, 40 nm, 45 nm, and 50 am thicknesses, respectively, are used in detecting the SPR angle of the water. As shown in FIG. 8, the SPR angle of 53 degrees is detected given all the thicknesses.

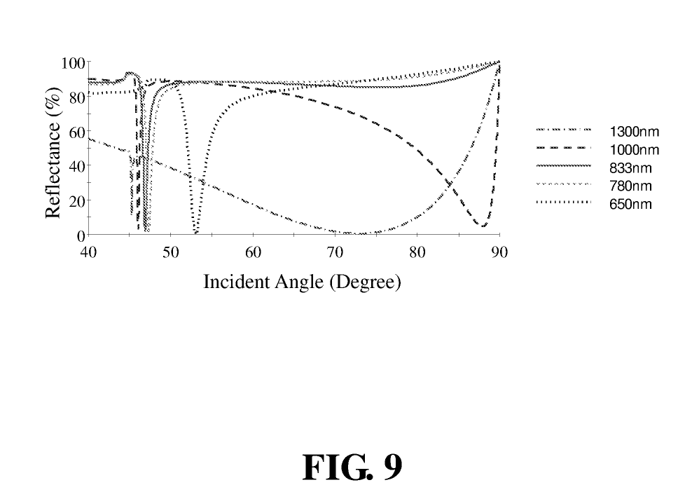

FIG. 9 shows effects of light wavelength on detecting the SPR angle of water using sensor 102 (shown in FIG. 2). Sensor 102 is fabricated according to its basic configuration, except that light of 650 nm, 780 nm, 833 nm, and 1000 nm wavelengths, respectively, are used in detecting the SPR angle of the water. As shown in FIG. 9, the SPR angle of 53 degrees is detected only when light of 650 nm wavelength is used. As further shown in FIG. 9, wavelength of 650 nm to 833 nm may be used for detecting the SPR angle, though a longer wavelength may show a smaller SPR angle.

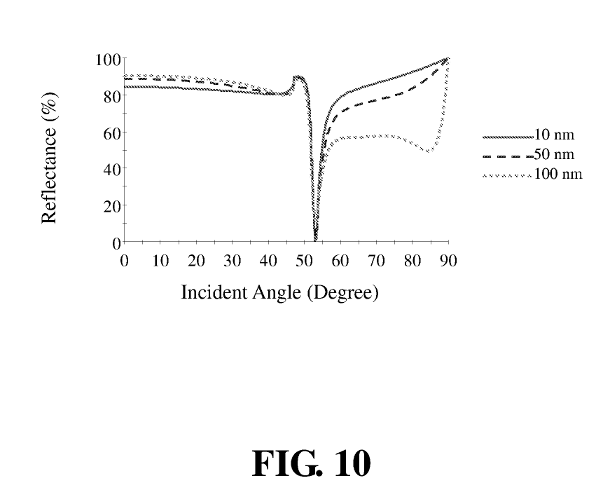

FIG. 10 shows effects of dielectric layer thickness on detecting the SPR angle of water using sensor 102 (shown in FIG. 2). Sensor 102 is fabricated according to its basic configuration, except that SiO₂ as dielectric layer 14 (shown in FIG. 2) of 10 nm, 50 nm, and 100 nm thicknesses, respectively, are used in detecting the SPR angle of the water. As shown in FIG. 10, the detection resolution becomes better when the thickness of dielectric layer 14 is smaller. A preferred thickness is within the range of 10-50 nm, and most preferably 10 nm.

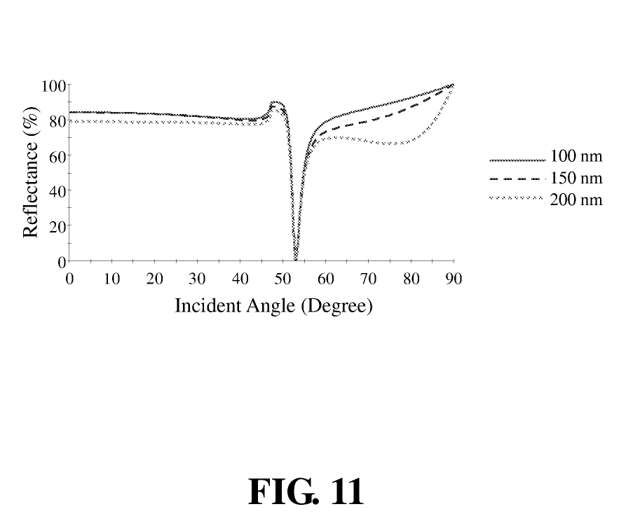

FIG. 11 shows effects of cathode layer thickness on detecting the SPR angle of water using sensor 102 (shown in FIG. 2). Sensor 102 is fabricated according to its basic configuration, except that ITO as cathode layer 13 (shown in FIG. 2) of 100 nm, 150 nm, and 200 nm thicknesses, respectively, are used in detecting the SPR angle of the water. As shown in FIG. 11, the detection resolution becomes better when the thickness of cathode layer 13 is smaller. A preferred thickness is within the range of 100-150 nm, and most preferably 100 nm.

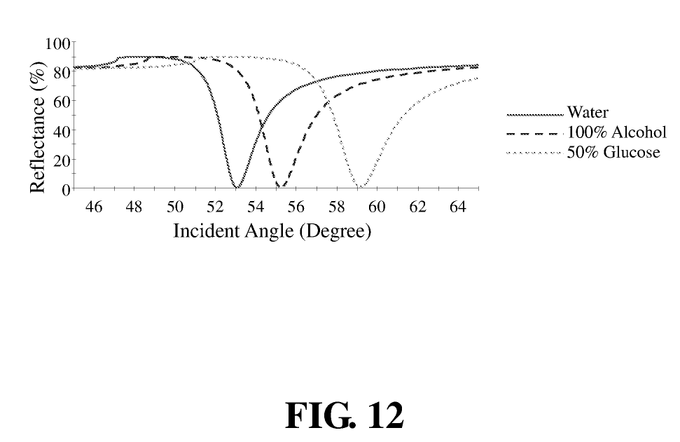

FIG. 12 shows a result of detecting the SPR angles of water, 100% ethanol, and 50% glucose solution using sensor 102 (shown in FIG. 2). Sensor 102 is fabricated according to its basic configuration, except that gold as sensing layer 15 (shown in FIG. 2) of 43 nm thicknesses, respectively, is used in detecting the SPR angles. As shown in FIG. 12, sensor 102 can detect the SPR angle of each of the three liquids. Further, sensor 102 can identify each of the liquids by detecting its SPR angle.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

What is claimed is:

1. A sensor for analyzing an analyte comprising:
an sensing element that is adapted to interface with the analyte;
an organic luminescent element that is adapted to excite surface plasmon resonance on the sensing element; and
a detector that is adapted to detect signals from the sensing element.

2. The sensor of claim 1 wherein the sensing element comprises a conductive material.

3. The sensor device as claimed in claim 1 wherein the sensing element comprises a multilayer structure.

4. The sensor of claim 1 wherein the sensing element comprises a microlens.

5. The sensor of claim 1 wherein the sensing element comprises a grating structure.

6. The sensor of claim 5 wherein the grating structure is two-dimensional.

7. The sensor of claim 1 wherein the sensing element comprises a periodic structure.

8. The sensor of claim 7 wherein the periodic structure includes a period size in a range from 10 nm to 1000 nm.

9. The sensor of claim 1 wherein the sensing element comprises a thin-film structure that includes a depth in the range of 1 nm to 500 nm.

10. The sensor of claim 1 wherein the sensing element comprises micro- or nano-particles.

11. The sensor of claim 1 wherein the organic luminescent element is adapted to emit light with a wavelength in the range of 300 to 850 nm.

12. The sensor of claim 1 wherein the organic luminescent element is adapted to emit light of about 650 nm.

13. The sensor of claim 1 wherein the organic luminescent element is substrate luminescent.

14. The sensor device of claim 1 wherein the organic luminescent element is cathode luminescent.

15. The sensor of claim 1 wherein the organic luminescent element comprises a substrate, an anode layer, an organic layer, and a cathode layer.

16. The sensor of claim 15 wherein the sensing element is attached to the substrate.

17. The sensor of claim 15 further comprising a dielectric layer that is attached to the sensing element.

18. The sensor of claim 1 further comprising an analyte-loading structure that is adapted to enable the analyte to interface with the sensing element.

19. The sensor of claim 18 wherein the analyte-loading structure comprises one or more microfluidic channels.

20. The sensor of claim 1 wherein the detector comprises a photodetector.
